(19) United States
(12) Patent Application Publication
(10) Pub. No.: US 2010/0299009 A1
(43) Pub. Date: Nov. 25, 2010

(54) METHOD FOR OPERATING A DRIVE DEVICE, IN PARTICULAR A HYBRID DRIVE DEVICE

(76) Inventor: Jens-Werner Falkenstein, Aalen (DE)

Correspondence Address: KENYON & KENYON LLP, ONE BROADWAY, NEW YORK, NY, 10004, US

(21) Appl. No.: 12/682,739

(22) PCT Filed: Sep. 10, 2008
(86) PCT No.: PCT/EP2008/061992

§ 371 Date: Aug. 13, 2010

(30) Foreign Application Priority Data
Oct. 19, 2007 (DE) 10 2007 050 113.9

(51) Int. Cl. G06F 19/00

(52) U.S. Cl. 701/22; 180/65.265

(57) ABSTRACT

A method for operating a drive device, in particular a hybrid drive device, of a vehicle, in particular a motor vehicle, having at least one internal combustion engine and at least one electrical machine as drive units, which are mechanically coupled to one another, as a function of a torque demand, in particular a filtered torque demand, in a normal operation, an ideal target torque for the particular drive unit being defined for each of the drive units and, in a dynamic operation, a target torque being defined for each of the drive units which together meet the torque demand.

### FIELD OF THE INVENTION

The present invention relates to a method for operating a drive device, in particular a hybrid drive device, of a vehicle, in particular a motor vehicle, having at least one internal combustion engine and at least one electrical machine as drive units, which are mechanically coupled to one another.

### BACKGROUND INFORMATION

Drive devices, which have both an internal combustion engine and also an electrical machine, are generally referred to as hybrid drive devices. The internal combustion engine and the electrical machine are mechanically coupled to one another directly or via a clutch, so that their torques add up to form a (total) drive torque of the drive device. Drive devices of this type are described, for example, in German Patent Application Nos. DE 10 2004 044 507 A1 and DE 10 2005 018 437 A1.

When defining target torques for the drive units, torques of the drive units are frequently ascertained. Because of the inaccuracies of corresponding actuators and sensors, however, the ascertained torque of a drive unit may permanently deviate from the target torque defined therefor, in particular at high torques. The deviation of the torque of a drive unit from the target torque defined therefor is typically to be compensated for. In particular in hybrid drive devices, the electrical machine is frequently used for the purpose of compensating for torque deviations of the internal combustion engine, because the electrical machine has a substantially higher dynamic range than the internal combustion engine. However, this has the result that permanent deviations are permanently balanced out by the electrical machine. In this way, for example, a defined charging strategy for the vehicle electrical system of the vehicle may not be maintained in the time average, whereby the vehicle electrical system is no longer sufficiently supplied or is excessively supplied with electrical power.

Furthermore, an adjustment of the ignition angle of the internal combustion engine is available for a rapid torque change to compensate for a torque deviation. The actual torque of the internal combustion engine may be reduced rapidly in particular by retarding its ignition angle. However, this results in elevated emissions associated with an elevated fuel consumption. A permanent balancing out of torque inaccuracies by interventions in the ignition angle is therefore fundamentally possible, but is inadvisable for the above-mentioned (efficiency) reasons.

### SUMMARY

According to the present invention, an example method is provided for operating a drive device, in particular a hybrid drive device, of a vehicle, in particular a motor vehicle, having at least one internal combustion engine and at least one electrical machine as drive units, which are mechanically coupled to one another, as a function of a torque demand, in particular a filtered torque demand, in normal operation of the drive device, an ideal target torque for the particular drive unit being defined for each of the drive units, and in dynamic operation, a target torque being defined for each of the drive units, which together meet the torque demand. Normal operation is to be understood for this purpose as quasi-steady-state normal operation of the drive device. Thus, in normal operation, an ideal target torque for the particular drive unit is defined for each of the drive units. This has the result that the particular drive unit is operated ideally in particular with respect to fuel consumption, a charging strategy, and/or pollutant emissions. The total drive target torque to be set deviates or may deviate from the torque demand by the operation using ideal target torques, because now inaccuracies of actuators and/or sensors for setting and/or detecting a torque of one of the drive units (which influences an ideal target torque) are no longer taken into account. A further substantial advantage is that in normal operation a charging strategy is maintained for an onboard electrical system of the vehicle or for an electrical accumulator associated with the electrical machine. In dynamic operation, in contrast, as already noted, target torques are defined for the drive units, which together meet the torque demand. The torque demand may correspond to a torque intended by the driver, for example, which the driver defines using an accelerator pedal, for example. Of course, it is also possible that the torque demand is carried out by another system of the vehicle, such as a cruise control system. In dynamic operation, the (total) drive target torque to be set thus corresponds to the torque demand. Driving comfort is thus ensured for the driver, in particular because the drive device meets the torque intended by the driver or the torque demand exactly.

The dynamic operation may be advantageously ascertained by detecting the time curve of at least one of the torques. A torque gradient is ascertained by detecting the time curve of one of the torques. By ascertaining this torque gradient, it may be determined whether the drive device is to be operated or is operated in normal operation or dynamic operation.

The dynamic operation is preferably ascertained as a function of at least one threshold value which may be defined. This threshold value is, for example, a torque gradient threshold value, it being determined upon exceeding the torque gradient threshold value that the drive device is operated/is to be operated in dynamic operation. Small torque changes or demands are thus generally suppressed, so that they do not affect the fuel consumption, the emissions, and/or the charging strategy of the vehicle.

The threshold value is expediently defined as a function of an instantaneous operating state of the drive device. The threshold value may be defined as a function of the entire drive device or as a function of the operating state of one or more drive units of the drive device. Thus, for example, when defining the threshold value, the charge state of the electrical accumulator associated with the electrical machine, the operating state of at least one drive unit, and/or an engaged gear of a transmission of the drive device may be taken into account.

In addition, an operating state which is important for the driving comfort, such as a zero crossing of a transmission output torque, may influence the threshold value. The threshold value may also be modified in the event of emergency operation of a drive unit (for example, in the event of defects of actuators or sensors), up to complete deactivation of the dynamic operation.

The ideal target torques are preferably defined in particular as a function of the current operating states of the drive units, the drive device, and/or an onboard electrical system of the vehicle. The ideal target torques are thus defined in such a manner that, for example, the fuel consumption is set optimally as a function of the operating temperature of the internal combustion engine and/or the charge state of the electrical accumulator.

According to a refinement of the present invention, in dynamic operation, a compensation target torque is defined for at least one of the drive units to balance out a deviation of the drive target torque from the torque demand. For this purpose, for example, it is thus defined that in dynamic operation, for example, if the ideal defined target torques deviate from the torque demand together, a compensation target torque is applied to at least one of the drive units, which is used for the purpose of balancing out or compensating for this deviation between the drive target torque (total drive target torque) to be set and the torque demand, so that the target torques of the drive units together meet the torque demand exactly. Alternatively thereto, it is possible to define the ideal target torques for the individual drive units in such a way that, based on a torque demand and as a function of the operating state of the drive device and/or the drive units, an optimization target torque is defined for the drive units to set the ideal target torques.

Furthermore, it is provided that the drive target torque to be set is defined to be smooth at least in a transition from normal operation to dynamic operation. Sudden torque peaks on the drive train are thus avoided and the comfort of the occupants of the vehicle is increased.

The target torques of the drive units in normal operation, in dynamic operation, and/or in the transition from normal into dynamic operation may be advantageously defined to be smooth.

According to an advantageous refinement of the present invention, in normal operation the gradient of the drive target torque to be set is defined within a tolerance band, which can be defined, around the gradients of the torque demand. A temporary deviation of the target torque of at least one of the drive units from the ideal target torque is advantageously tolerated. A comfortable response to a driving input and/or torque demand may thus be ensured. In addition, jumps in the gradient of the drive target torque to be set in transitions between the modes of operation are reduced.

Furthermore, it is provided that during a zero crossing of the torque demand, the drive target torque to be set is set equal to the torque demand. A ramping which allows the smooth setting of the target torques is expediently set in such a way that during the zero crossing of the torque demand, the drive target torque to be set already corresponds precisely to the torque demand or the filtered torque demand.

Finally, upon detection of an external influence on the torque in normal operation, the method changes to dynamic operation. For example, if auxiliary units are switched in, such as an air conditioner compressor, which has a sensitive effect on the operating behavior of the drive device, this prevents a torque demand from being implemented inadequately, or electronic stability programs (ESP) or interventions of automated shift transmissions from being implemented inadequately.

### BRIEF DESCRIPTION OF THE DRAWINGS

The present invention is explained in greater detail below.

FIG. 1 shows a schematic view of an exemplary embodiment of an advantageous method.

FIG. 2 shows an exemplary embodiment of an advantageous method.

FIG. 3 shows a further exemplary embodiment of an advantageous method.

FIG. 4 shows a further exemplary embodiment of an advantageous method.

### DETAILED DESCRIPTION OF EXAMPLE EMBODIMENTS

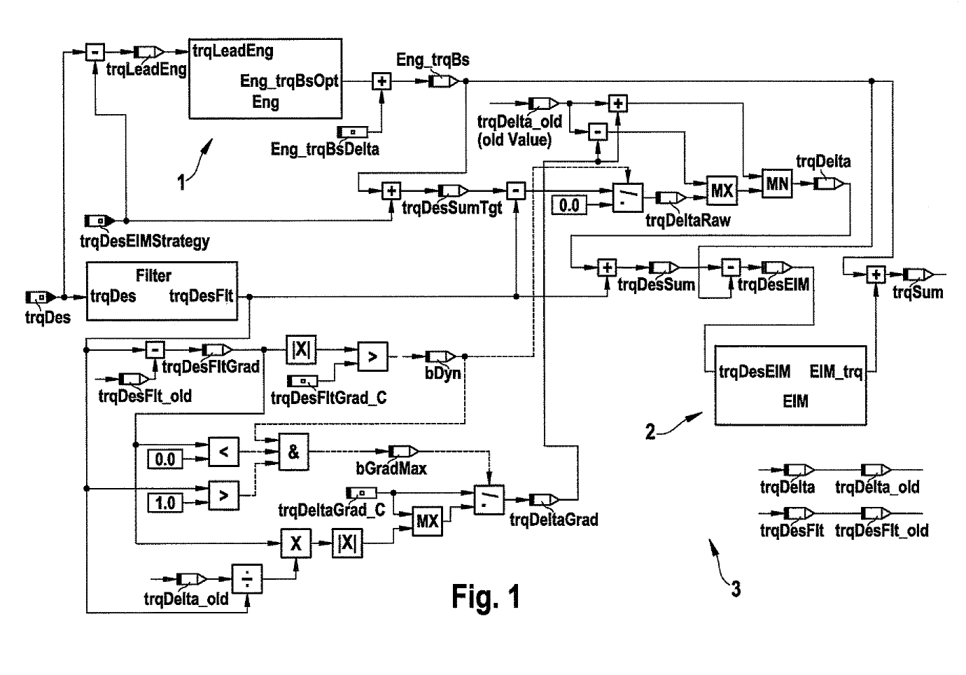

An exemplary embodiment of the method according to the present invention is shown in FIGS. 1 through 4. It is based on an internal combustion engine 1 (gasoline engine) having intake manifold injection, electronic gas pedal (E gas, electronic throttle valve), and catalytic converter. A flywheel of internal combustion engine 1 is coupled to electrical machine 2 (crankshaft starter generator). Internal combustion engine 1 and electrical machine 2 together form a drive device 3 of a motor vehicle.

Modern gasoline engines typically have an electronic throttle valve for the air mass flow rate regulation, which is activated by the engine controller. Lead target torque trgLeadEng for the internal combustion engine shown in FIG. 1 acts on an air pathway. An air mass flow rate is set accordingly by suitable activation of the throttle valve. At the ideal ignition angle, internal combustion engine 1 generates torque Eng_trqBs, which is designated as the base torque. In non-steady-state operation, dynamic charging effects act in the intake manifold (intake manifold dynamic range), and the transition from lead target torque trqLeadEng to base torque Eng_trqBs may be approximately described with the aid of a first-order series circuit of a response time element and a delay element (PT1). The engine controller of a modern internal combustion engine 1 may ascertain instantaneous base torque Eng_trqBs on the basis of measured and estimated variables, for example, from engine speed, intake manifold pressure, or the signal of an air mass sensor, etc.

Because of inaccuracies of actuators and sensors, base torque Eng_trqBs may permanently deviate from lead target torque trgLeadEng, in particular at high torques.

In the method according to FIG. 1, the response time behavior and the delay behavior are modeled in block “Eng”. Variable Eng_trqBsDelta simulates a permanent inaccuracy in base torque Eng_trqBs of internal combustion engine 1.

The torque activation of a modern electrical machine 2 has a much higher dynamic range than the intake manifold dynamic range of an internal combustion engine 1; in the method according to FIG. 1, the delay in the torque activation of the electrical machine is neglected, actual torque EIM_trq approximately corresponding to target torque trqDesEIM (block “EIM”).

Because of the high dynamic range of electrical machine 2, it may advantageously be used, for example, to compensate for a torque change in the internal combustion engine which is delayed because of the intake manifold dynamic range when a drive target torque is changed. This is designated as non-steady-state balancing and allows a high dynamic range of the drive. The intake manifold dynamic range is typically strongly dependent on the operating point of the internal combustion engine; modeling images the reality only inadequately. A simple controller is thus not possible; for the non-steady-state balancing, base torque Eng_trqBs, which is ascertained by the controller on the basis of the measured variables, must be used. In parallel-hybrid drives, an electrical machine may be coupled directly to the flywheel of the internal combustion engine. A simpler approach for the non-steady-state balancing in similar drives is to calculate target torque trqDesEIM for the electrical machine from the difference of (possibly filtered) drive target torque trqDesFlt for the entire drive (for example, from driver or driver assistance system) and base torque Eng_trqBs:

trqDesEIM=trqDesFlt−Eng_{—}trqBs

The electrical machine balances out a delayed increase or decrease in the base torque.

Lead target torque trqLeadEng may be selected so that the electrical machine approximately sets a predetermined strategy target torque (charge target torque) trqDesEIMStrategy, for example, using:

trqLeadEng=trqDesFlt−trqDesEIMStrategy

However, permanently existing inaccuracies in the base torque (or deviations of base torque Eng_trqBs from lead target torque trgLeadEng) act on the electrical machine. This has the result that electrical machine 2 permanently compensates for inaccuracies of internal combustion engine 1 and thus does not maintain a defined strategy target torque (charge target torque) trqDesEIMStrategy in the time average. An onboard electrical system is no longer supplied sufficiently or is excessively supplied with electrical power.

For a (rapid) reduction of drive target torque trqDesFlt, retarding of the ignition angle is also available in addition to interventions in target torque trqDesEIM of the electrical machine, but retarding is associated with elevated consumption and elevated emissions. For interventions in the ignition angle, because of the high possible dynamic range, an analogy exists to interventions in target torque trqDesEIM of the electrical machine. The permanent compensation of an excessive base torque as a result of inaccuracies by ignition angle interventions is fundamentally possible, but is inadvisable for reasons of efficiency.

The advantageous method provides, in a normal operation (no external interventions active) of the drive device, operating internal combustion engine 1 a torque (Eng_trqBs) which is ideal at the moment and operating the electrical machine(s) at torques (trqDesEIMStrategy) which are ideal at the moment and with drive target torque trqDesSum, which is to be set jointly by internal combustion engine 1 and electrical machine(s) 2, deviating from a defined (possibly filtered) drive target torque trqDesFlt, which corresponds to a torque demand, for example, from the driver, while in a dynamic operation, in particular without external interventions, drive target torque trqDesSum to be set precisely corresponding to defined drive target torque trqDesFlt by one or more units deviating from the torque which is ideal at the moment. The dynamic operation is detected on the basis of the time curve of one or more torques.

Furthermore, it is advantageous if the ramping of drive target torque trqDesSum to be set is carried out in the transition into the dynamic operation so that during a zero crossing of drive target torque trqDesFlt, drive target torque trqDesSum to be set already precisely corresponds to defined drive target torque trqDesFlt.

In addition, it is advantageous if the target torques for the individual units in the modes of operation of normal operation and dynamic operation and in the transition between these modes of operation are defined as ramped, i.e., smooth.

At ideal ignition angle, an actual torque of internal combustion engine 1 corresponds to a base torque Eng_trqBs. The base torque represents the torque of internal combustion engine 1 which is ideal at the moment. For the exemplary embodiment, ignition angle interventions are not taken into account because of the analogy to interventions using electrical machine 2. The described method may be expanded in hybrid vehicles by ignition angle interventions. The described method may also be used in conventional vehicles, in that interventions in a target torque trqDesEIM of the electrical machine are replaced by interventions in a target torque for the ignition angle coordination of the internal combustion engine.

The following assumptions apply for the exemplary embodiment for the sake of simplicity:
1. A drive target torque trqDes is selected so that electrical machine 2 and internal combustion engine 1 are operated within their allowed operating ranges. Measures for setting limits if the drive target torque does not meet this requirement are not shown.
2. No ignition angle intervention is carried out on internal combustion engine 1; base torque Eng_trqBs corresponds to the actual torque of internal combustion engine 1. Measures for the coordination of ignition angle interventions are not shown.

Actual torque Eng_trqBs of the internal combustion engine and an actual torque EIM_trq of electrical machine 2 add up to form actual torque trqSum of the entire drive device.

A drive target torque trqDes for the entire drive is defined, for example, by the driver or by driver assistance systems, in the event of external interventions including ESP, automated shift transmissions, etc. For reasons of comfort, a filtered drive target torque trqDesFlt is generated therefrom in a block “filter”; the filter effect may be modified or turned off in the event of external interventions.

In addition, a difference of filtered drive target torque trqDesFlt from the prior computing step of the sampling system to the current computing step is calculated using trqDesFltGrad (sampling time T):

trqDesFltGrad(kT)=trqDesFlt(kT)−trqDesFlt[(k−1)T]

A memory element trqDesFlt_old contains the value of filtered drive target torque trgDesFlt from the prior computing step:

trqDesFlt_old=trqDesFlt[(k−1)T]

Variable trqDesFltGrad describes the “gradient” of filtered drive target torque trqDesFlt.

An operating strategy (not described in greater detail) ascertains a strategy target torque trqDesEIMStrategy for electrical machine 2, at which the power demand of an onboard electrical system is met.

Lead target torque trqLeadEng for internal combustion engine 1 is calculated so that the following equation applies:

trqDesEIMStrategy+trqLeadEng=trqDes

The transition from lead target torque trqLeadEng to a base torque without inaccuracies Eng_trqBsOpt is described using a first-order series circuit of a response time element and a delay element (PT1) (block “Eng”). Variable Eng_trqBsDelta models an additive inaccuracy in base torque Eng_trqBs of internal combustion engine 1.

An ideal drive target torque trqDesSumTgt results via addition of torques Eng_trqBs which are ideal at the moment of internal combustion engine 1 and trqDesEIMStrategy of electrical machine 2:

trqDesSumTgt=Eng_{—}trqBs+trqDesEIMStrategy

If no external interventions are active, in the exemplary embodiment, “gradient” (change between two computing steps) trqDesFltGrad of filtered drive target torque (=torque demand) trqDesFlt is used for detecting the dynamic operation. If trqDesFltGrad has a greater absolute value than a (positive) threshold value trqDesFltGrad C, dynamic operation exists with activation signal bDyn=true; otherwise, with bDyn=false, (quasi-steady-state) normal operation exists.

Other conditions are also possible for detecting the dynamic operation. For example, dynamic operation may be recognized if the absolute value of the deviation of the torque demand or of filtered drive target torque trqDesFlt from unfiltered drive target torque trqDes exceeds a “defined” threshold value.

A target value trqDeltaRaw for a ramped delta torque trqDelta is ascertained as a function of activation signal bDyn. Delta torque trqDelta follows target value trqDeltaRaw with a permissible ramp slope, which is limited in absolute value by (positive) limit trqDeltaGrad_C:

trqDelta(kT)=MIN[(MAX(trqDeltaRaw(kT), (trqDelta[(k−1)T]−trqDeltaGrad_{—}C)]),

(trqDelta [(k−1)T]trqDeltaGrad_C)]

Memory element trqDelta_old contains the value of delta torque trqDelta from the prior computing step:

trqDelta_old=trqDelta [(k−1)T].

(Quasi-steady-state) normal operation:

With bDyn=false, target value trqDeltaRaw for ramped delta torque trqDelta results from the difference:

StrqDeltaRaw=trqDesSumTgt−trqDesFlt.

In the steady state, ramped delta torque trqDelta corresponds to raw value trqDeltaRaw, and thus drive target torque trqDesSum to be set corresponds to ideal drive target torque trqDesSumTgt. Inaccuracies in the base torque act on drive target torque trqDesSum to be set and on summed actual torque trqSum. Internal combustion engine 1 is operated at torque Eng_trqBs which is ideal at the moment and electrical machine 2 is operated at torque trqDesEIMStrategy which is ideal at the moment:

trqDesEIM=trqDesEIMStrategy.

Electrical machine 2 meets the power demand of an onboard electrical system in spite of inaccuracies in the base torque.

A change in filtered drive target torque trqDesFlt from the steady state is considered hereafter, trqDesEIMStrategy not being changed. Base torque Eng_trqBs initially does not change because of the delaying effect of the air pathway dynamic range; ideal drive target torque trqDesSumTgt thus also remains approximately constant. Under these conditions, if “gradient” (change between two computing steps) trqDesFitGrad of filtered drive torque trqDesFlt has an absolute value less than (positive) limit trqDeltaGrad_C:

|trqDesFltGrad|≦trqDeltaGrad_C,

this also applies for the “gradient” of raw value trqDeltaRaw:

|trqDeltaRaw(kT)−trqDeltaRaw [(k−1)]|≦trqDeltaGrad_{—}C.

In this case, ramped delta torque trqDelta still corresponds to raw value trqDeltaRaw and drive target torque trqDesSum to be set still corresponds to ideal drive target torque trqDesSumTgt.

If “gradient” trqDesFltGrad of filtered drive target torque trqDesFlt has an absolute value exceeding the limit for maximum ramp slope trqDeltaGrad_C:

|trqDesFltGrad|>trqDeltaGrad_C,

this has an effect on drive target torque trqDesSum to be set.

In the general case, for “gradient” trqDesSumGrad of drive target torque trqDesSum to be set, where

trqDesSumGrad(kT)=trqDesSum (kT)−trqDesSum [(k−1) T]

and gradient trqDesSumTgtGrad of ideal drive target torque trqDesSumTgt where

trqDesSumTgtGrad(kT)=trqDesSumTgt(kT)−trqDesSumTgt[(k−1)T]:

trqDesSumGrad=trqDesSumTgtGrad

if |trqDesSumTgtGrad−trqDesFltGrad|≦trqDeltaGrad_C

and

trqDesSumGrad=trqDesSumFltGrad−trqDeltaGrad_C

if trqDesSumTgtGrad−trqDesFltGrad<−trqDeltaGrad_C

and

trqDesSumGrad=trqDesSumFltGrad+trqDeltaGrad_C

if trqDesSumTgtGrad−trqDesFltGrad>trqDeltaGrad_C.

“Gradient” trqDesSumGrad of drive target torque trqDesSum to be set lies within a tolerance band having limits ±trqDeltaGrad_C around “gradient” trqDesFltGrad of defined drive target torque trqDesFlt. A temporary deviation from ideal drive target torque trqDesSumTgt and thus from torques Eng_trqBs which are ideal at the moment, trqDesEIMStrategy is tolerated to ensure a comfortable response to a change in defined drive target torque trqDesFlt (driver input).

Dynamic operation:

With bDyn=true, target value trqDeltaRaw for ramped delta torque trqDelta results as:

trqDeltaRaw=0.

During the transition into dynamic operation, delta torque trqDelta is ramped to 0 and then remains at 0. Drive target torque trqDesSum to be set corresponds to filtered drive target torque trqDesFlt. Inaccuracies in the base torque affect electrical machine 2. For reasons of comfort, maintaining filtered drive target torque trqDesFlt has priority.

Transitions between the modes of operation:

Drive target torque trqDesSum to be set is smooth because of the ramping of delta torque trqDelta, if filtered drive target torque trqDesFlt is defined to be smooth.

During the transition into the dynamic operation, delta torque trqDelta is ramped to 0. During a zero crossing of the transmission output torque, which results in tilting of the engine-transmission unit in its mounts and thus a load impact in the drive train, drive target torque trqDesFlt is typically specially shaped. At the zero crossing, drive target torque trqDesSum to be set is to follow the curve of trqDesFlt exactly for reasons of comfort, i.e., the delta torque is already to be reduced at trqDelta=0.

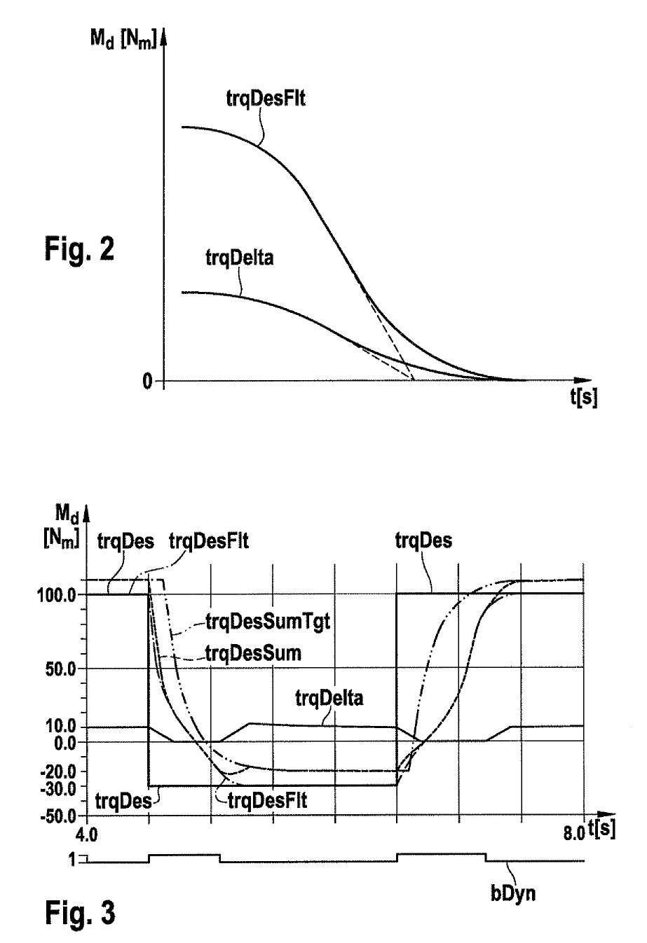

FIG. 2 illustrates, in a diagram, the procedure according to the present invention in order to ensure the above requirement, in which torque M_{d} is plotted over time t. The diagram is based on the following example: trqDesFlt and trqDelta are positive, i.e., a transition into the dynamic operation has occurred shortly beforehand. The “gradient” of trqDesFlt is negative; a zero crossing of the transmission output torque is coincident with a zero crossing of drive target torque trqDesSum to be set. Both torques trgDesFlt and trqDelta are simultaneously 0 if the gradients behave as do the absolute variables in each computing step:

(trqDelta(kT)−trqDelta [k−1]T])/trqDelta(kT)=(trqDesFlt(kT)−trqDesFlt[(k−1)T])/trqDesFlt(kT)

The gradients are symbolized in FIG. 2 by the tangents plotted using dashed lines, which intersect on the abscissa (zero level of the torques).

In dynamic operation, in the event of positive trgDesFlt (in the example if trqDesFlt>1 Nm, to avoid division by 0) and negative “gradient” trqDesFltGrad, an activation signal bGradMax is set, as shown in FIG. 1. According to the above relationship, using the MAX condition, limit trqDeltaGrad for the absolute value of the permissible ramp slope is increased if necessary beyond the value of parameter trqDeltaGrad_C. If required, trqDelta thus goes more rapidly to 0 and is completely reduced at the zero crossing of trqDesFlt with trqDelta=0. This procedure is to be seen as an example that other mechanisms are also possible, for example, to already completely reduce trqDelta a time span before the actual zero crossing of trqDesFlt.

External interventions:

In the event of external interventions, such as electronic stability programs (ESP), interventions of automatic shift transmissions, etc., a rapid implementation of drive target torque trgDesFlt is necessary, and a sudden change in delta torque trqDelta thus occurs:

trqDelta=0.

Such a changeover is not shown in the figures.

FIG. 3 shows exemplary simulation results of a simulation model according to FIG. 1 for sudden changes in unfiltered drive target torque trqDes between −30 Nm and 100 Nm. Drive target torque trqDesFlt follows with a corresponding delay; the flatter curve in the area of its zero crossing is clearly recognizable in order to avoid load impacts in the drive train. The strategy target torque is trqDesEIMStrategy=−20 Nm during the entire simulation. Eng_trqBsDelta=10 Nm is assumed as the inaccuracy in the base torque of the internal combustion engine. In normal operation with bDyn=false, drive target torque trqDesSum to be set corresponds to ideal drive target torque trqDesSumTgt. Electrical machine 2 is operated at torque trqDesEIMStrategy which is ideal at the moment and meets the requirements of the vehicle electrical system. In dynamic operation with bDyn=true, delta torque trqDelta=0, drive target torque trqDesSum to be set corresponds to filtered drive target torque trqDesFlt. The transitions are ramped.

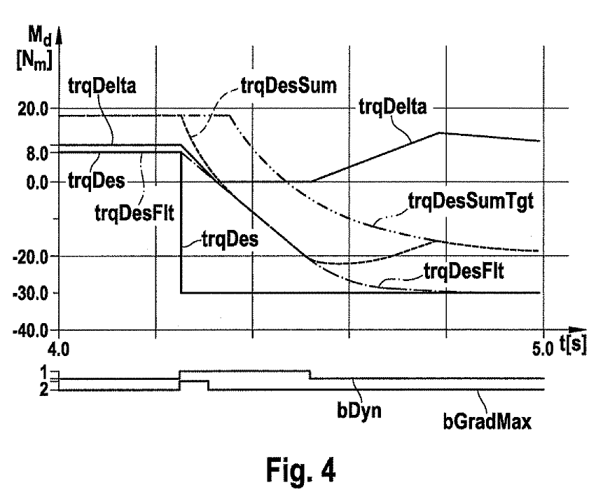

FIG. 4 shows further exemplary simulation results of the simulation model according to FIG. 1. Unfiltered drive target torque trqDes jumps from 8 Nm to −30 Nm, and drive target torque trqDesFlt follows with a corresponding delay. Upon activation signal bGradMax=true, limit trqDeltaGrad for the absolute value of the permissible ramp slope is increased beyond the value of parameter trqDeltaGrad_C. Delta torque trqDelta thus drops more rapidly and is reduced to trqDelta=0 at the zero crossing of trqDesFlt. The remaining variables are selected according to the exemplary simulation from FIG. 3.

Alternatively to the torques considered in the exemplary embodiment, the method may also be applied to output powers.

1-11. (canceled)

12. A method for operating a hybrid drive device of a motor vehicle, having at least one internal combustion engine and at least one electrical machine as drive units, which are mechanically coupled to one another, the method comprising:
defining in a normal operation an ideal target torque for each of the drive units as a function of torque demand; and
defining in a dynamic operation a target torque for each of the drive units which together meet the torque demand.

13. The method as recited in claim 12, further comprising:
ascertaining the dynamic operation by detecting a time curve of at least one of the torques.

14. The method as recited in claim 12, further comprising:
ascertaining the dynamic operation as a function of at least one predefinable threshold value.

15. The method as recited in claim 14, wherein the threshold value is defined as a function of an instantaneous operating state of the hybrid drive device.

16. The method as recited in claim 12, wherein the target torques are defined as a function of current operating states of at least one of: the drive units, the hybrid drive device, and an onboard electrical system of the vehicle.

17. The method as recited in claim 12, wherein, in dynamic operation, a compensation target torque is defined for at least one of the drive units to balance out a deviation of a drive target torque from the torque demand.

18. The method as recited in claim 12, wherein the target torque is defined to be smooth at least during a transition from normal operation to dynamic operation.

19. The method as recited in claim 12, wherein the target torques of the drive units are defined to be smooth in at least one of normal operation, dynamic operation, and during the transition from normal into dynamic operation.

20. The method as recited in claim 12, wherein, in normal operation, a gradient of a drive target torque is defined within a predefinable tolerance band around a gradient of the torque demand.

21. The method as recited in claim 12, wherein, during a zero crossing of the torque demand, the drive target torque is set equal to the torque demand.

22. The method as recited in claim 12, wherein, upon detecting an external influence on the torque in normal operation, a change is made into dynamic operation.
